(19) United States
(12) Patent Application Publication
(10) Pub. No.: US 2025/0054270 A1
(43) Pub. Date: Feb. 13, 2025

(54) LABELED TRAINING DATA CREATION ASSISTANCE DEVICE AND LABELED TRAINING DATA CREATION ASSISTANCE METHOD

(71) Applicant: Hitachi High-Tech Corporation, Minato-ku, Tokyo (JP)

(72) Inventors: Toshinori YAMAUCHI, Tokyo (JP); Yasuhiro YOSHIDA, Tokyo (JP); Masayoshi ISHIKAWA, Tokyo (JP); Takefumi KAKINUMA, Tokyo (JP); Masaki HASEGAWA, Tokyo (JP); Kentaro OHIRA, Tokyo (JP); Yasutaka TOYODA, Tokyo (JP)

(73) Assignee: Hitachi High-Tech Corporation, Minato-ku, Tokyo (JP)

(21) Appl. No.: 18/718,670

(22) PCT Filed: Dec. 17, 2021
(86) PCT No.: PCT/JP2021/046717

§ 371 Date: Jun. 11, 2024

(51) Int. Cl. G06V 10/44; G06T 7/00; G06T 7/70; G06V 10/762; G06V 10/774; G06V 20/70

(52) U.S. Cl. CPC G06V 10/44; G06T 7/0008; G06T 7/70; G06V 10/762; G06V 10/774; G06V 20/70; G06T 2207/20084; G06T 2207/30148

(57) ABSTRACT

Provided is a training data creation assistance device which, for an image on which a plurality of defects in an image are reflected, enables the efficient collection/selection of a training image by specifying a feature amount corresponding to each of the defects in a way that a peripheral area of the defect is also considered and by mapping the specified feature amount to a low dimensional space. The training data creation assistance device is characterized by comprising: an image recognition unit which, on the basis of a trained result, extracts feature amounts from an input image, performs image processing with the feature amounts, and outputs a recognition result; a feature amount specification unit which receives an input of one or more prediction results or designated areas from the image recognition unit, and specifies the feature amounts respectively corresponding to the prediction results or designated areas; an inspection result feature amount database in which the feature amounts of the respective prediction results or designation areas are stored; and a dimension reduction unit which performs dimensional reduction on the feature amounts stored in the inspection result feature amount database, and projects the feature amounts into a low-dimensional space, wherein the feature amount specification unit includes an important region calculation unit which, for each of the prediction results or each of the designated areas, obtains an important area that holds peripheral area information including a detected area of the prediction result or the designated area; and a feature amount extraction unit which extracts the feature value corresponding to each of the prediction results or each of the designated areas by weighting the feature value extracted by the image recognition unit in the importance area.

### TECHNICAL FIELD

The present invention relates to a labeled training data creation assistance device and a method therefor for assistance in creation of labeled training data in machine learning, and more particularly, to a technique effectively applied to an inspection and measurement device that performs automatic inspection or measurement using an image recognition model constructed by machine learning.

### BACKGROUND ART

On a manufacturing line for a semiconductor, a liquid crystal panel, and the like, if a defect occurs at the beginning of a process, work in subsequent processes is wasted, and therefore, an inspection process is set up at each key point in the process to check and maintain a certain yield rate while proceeding with manufacturing. In the inspection process, for example, a critical dimension-SEM (CD-SEM) to which a scanning electron microscope (SEM) is applied, or a defect review-SEM is used.

In the inspection process, presence or absence of a defect or an abnormality is checked with respect to an image captured by the above-described inspection device. In recent years, highly accurate automatic inspection is possible using an image recognition model constructed by machine learning.

As a background art of the present technical field, for example, there is a technique as disclosed in PTL 1. PTL 1 discloses a “labeled training data creation assistance device that assists creation of labeled training data used for learning of a classifier that classifies data”.

Specifically, first, labeled training data in which any one of a plurality of categories is taught is subjected to dimension reduction by principal component analysis and mapped to a low-dimensional area. At this time, a principal component axis and an area range are appropriately set, and the resulting discretized distribution image appropriately assists in understanding of a distribution state of the labeled training data.

### CITATION LIST

### Patent Literature

PTL 1: JP2019-66993A

### SUMMARY OF INVENTION

### Technical Problem

Here, accuracy of the image recognition model depends on a learning image used for learning at a development stage.

Therefore, during inspection at the manufacturing site, if characteristics of the captured image change from the learning image due to changes in a circuit manufacturing process or the like, detection accuracy of a developed model may decrease. In this case, it is necessary to maintain performance by selecting the learning image from an inspection image again at the manufacturing site and re-learning the model. However, it is difficult to individually check a large number of inspection images from the viewpoint of cost, time, and the like.

According to PTL 1, by expressing multi-dimensional feature data of the labeled training data on a low-dimensional space, a human can visually recognize the distribution state of the labeled training data. Therefore, by applying the technique to the inspection image and mapping the inspection image to the low-dimensional space, it is possible to efficiently collect and select an image from the distribution.

However, in PTL 1, since an input is the entire image, it is applicable only when one defect appears in the image, but it is not applicable when a plurality of defects appear in the image. In this case, it is necessary to identify feature data corresponding to each defect and map the feature data to the low-dimensional space, however, in this technique, since the feature data of the entire image is mapped, the feature data for each defect cannot be accurately reflected. In addition, when the feature data corresponding to each defect is identified, it is important to identify feature data of a peripheral area at the same time in addition to an area where the defect is present. This is particularly important in generating labeled training data of an image recognition model in which a plurality of defects appear in an image and the defects are individually detected (details are described in the embodiment).

Therefore, an object of the invention is to provide a labeled training data creation assistance device and a labeled training data creation assistance method using the same, which can efficiently collect and select a learning image by identifying feature data corresponding to each defect in an image in which a plurality of defects appear in the image in consideration of a peripheral area thereof and mapping the feature data to a low-dimensional space.

### Solution to Problem

In order to solve the above problems, the invention provides a labeled training data creation assistance device including: an image recognition unit configured to extract, based on a learning result, feature data from an input image, perform an image process with the feature data, and output a recognition result; a feature data identifying unit configured to receive one or more prediction results or designated areas from the image recognition unit as an input, and identify the feature data corresponding to each of the prediction results or each of the detection areas; an inspection result feature data database in which the feature data for each of the prediction results or each of the designated areas is stored; and a dimension reduction unit configured to perform dimension reduction on the feature data stored in the inspection result feature data database and project the feature data onto a low-dimensional space. The feature data identifying unit includes, for each of the prediction results or each of the designated areas, an important area calculation unit configured to determine an important area that holds information on a peripheral area including a detection area of the prediction result or the designated area, and a feature data extraction unit configured to extract the feature data corresponding to each of the prediction results or each of the designated areas by weighting the feature data extracted by the image recognition unit with the important area.

In addition, the invention provides a labeled training data creation assistance method for assistance of creation of labeled training data in machine learning, the method includes: (a) a step of individually detecting types and positions of a plurality of defects appearing in an inspection image; (b) a step of identifying feature data for each defect based on a result detected in step (a) and storing the feature data in a database; and (c) a step of performing dimension reduction on the feature data stored in the database, projecting the feature data onto a low-dimensional space, and displaying a result of projection on a display unit.

### Advantageous Effects of Invention

According to the invention, a labeled training data creation assistance device and a labeled training data creation assistance method using the same can be implemented, which can efficiently collect and select a learning image by identifying feature data corresponding to each defect in an image in which a plurality of defects appear in the image in consideration of a peripheral area thereof and mapping the feature data to a low-dimensional space.

Accordingly, it is possible to roughly narrow down images that are candidates for labeled training data from a data distribution in a low-dimensional space, and it is possible to efficiently create the labeled training data.

Problems, configurations, and effects other than those described above will be made clear by the following description of the embodiments.

### BRIEF DESCRIPTION OF DRAWINGS

FIG. 1 is a diagram showing a schematic configuration of a labeled training data creation assistance device according to the invention.

FIG. 2 is a block diagram showing a configuration of the labeled training data creation assistance device according to Embodiment 1 of the invention.

FIG. 3 is a flowchart showing a process performed by the labeled training data creation assistance device of FIG. 2.

FIG. 4 is a flowchart showing a process performed by a feature data identifying unit 6 of FIG. 2.

FIG. 5 is a diagram showing an example of a storage form of an inspection result feature data DB 17 of FIG. 2.

FIG. 6 is a block diagram showing a system configuration related to a storage process of a learning result feature data DB 18 of FIG. 2.

FIG. 7 is a flowchart showing a process according to the system configuration of FIG. 6.

FIG. 8 is a diagram showing an example of a dimension reduction result by a dimension reduction unit 8 of FIG. 2.

FIG. 9 is a diagram showing a display example of a display unit 20 of FIG. 2.

FIG. 10 is a diagram showing an effect of an important area calculation unit 15 of FIG. 2.

FIG. 11 is a diagram showing the effect of the important area calculation unit 15 of FIG. 2.

FIG. 12 is a block diagram showing a configuration of a labeled training data creation assistance device according to Embodiment 2 of the invention.

FIG. 13 is a flowchart showing a process performed by the labeled training data creation assistance device of FIG. 12.

FIG. 14 is a diagram showing an example of a storage form of an imaging result DB 29 of FIG. 12.

FIG. 15 is a diagram showing a display example of a display unit 34 of FIG. 12.

### DESCRIPTION OF EMBODIMENTS

Hereinafter, embodiments of the invention will be described with reference to the drawings. In the drawings, the same components are denoted by the same reference signs, and a detailed description of the repeating components is omitted.

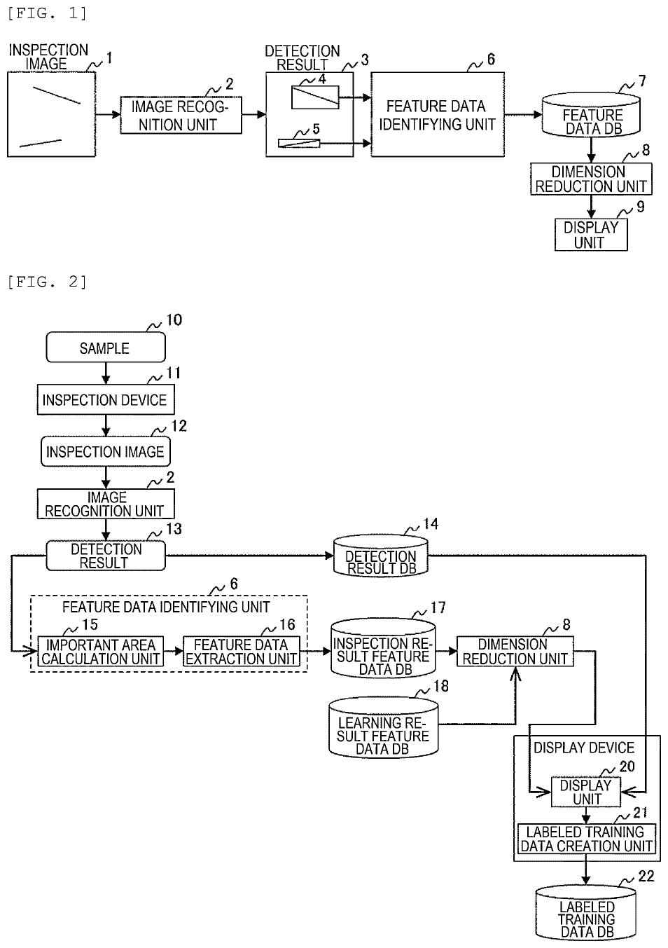

First, an outline of a labeled training data creation assistance device according to the invention will be described with reference to FIG. 1. FIG. 1 is a diagram showing a schematic configuration of the labeled training data creation assistance device according to the invention.

As shown in FIG. 1, in the invention, the feature data identifying unit 6 identifies feature data for each defect for a detection result 3 of an image recognition unit 2 for an inspection image 1, and stores the feature data in a feature data DB 7. Further, the dimension reduction unit 8 performs dimension reduction on the feature data identified by the feature data identifying unit 6 stored in the feature data DB 7 and projects the feature data onto a low-dimensional space, and a display unit 9 displays a result thereof.

As shown in the detection result 3 of FIG. 1, the image recognition unit 2 individually detects a type and a position of the defect shown in the inspection image 1 as a detection result 4 and a detection result 5. The feature data identifying unit 6 receives the results detected by the image recognition unit 2 and identifies the feature data for each detection result. Since the dimension reduction unit 8 performs dimension reduction on the feature data for each detection result and the display unit 9 displays the result, the display unit 9 displays data points after the dimension reduction corresponding to each defect. For example, when two defects are present in the image and the image recognition unit 2 separately detects the defects, two data points corresponding to the defects are separately displayed on the display unit 9.

Hereinafter, a specific configuration of the labeled training data creation assistance device described in FIG. 1 and a labeled training data creation assistance method using the same will be described.

### Embodiment 1

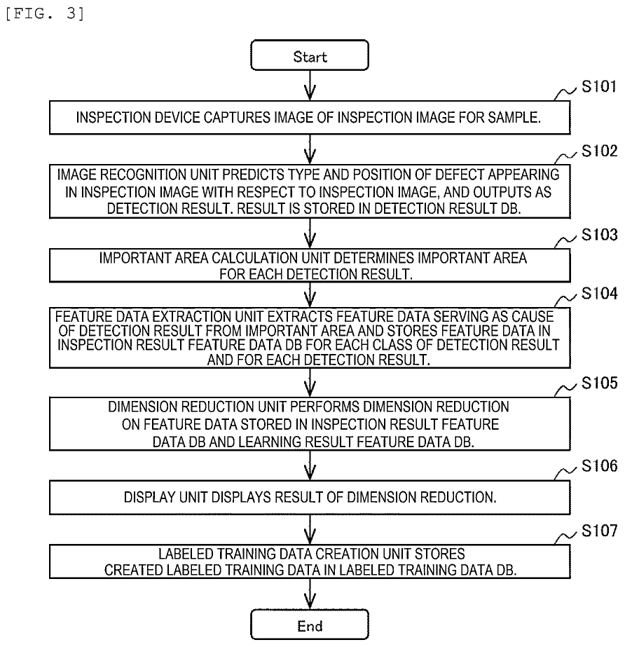

A specific configuration for implementing functions described in FIG. 1 will be described with reference to FIG. 2. FIG. 2 is a block diagram showing a configuration of the labeled training data creation assistance device according to Embodiment 1 of the invention.

An inspection device 11 captures an image of an inspection image 12 for a sample 10. The sample 10 is, for example, a semiconductor wafer, and the inspection device 11 is, for example, a defect inspection device using a mirror electron microscope that forms an image of mirror electrons, or an optical defect inspection device.

The image recognition unit 2 performs defect inspection on the acquired inspection image 12. The image recognition unit 2 extracts feature data from the inspection image 12 and detects a defect appearing in the inspection image 12 based on the extracted feature data. When a plurality of defects appear in the inspection image 12, the image recognition unit 2 detects the defects individually. Therefore, the image recognition unit 2 has a model capable of predicting a type and a position of the defect. As the image recognition model in the image recognition unit 2, for example, a single shot multibox detector (SSD) or a RetinaNet implemented by a convolution neural network (CNN) is used. The image recognition unit 2 outputs a prediction result as a detection result 13 and stores the result in a detection result DB 14.

The feature data identifying unit 6 includes the important area calculation unit 15 and a feature data extraction unit 16. Details of process contents of each component will be described later.

The important area calculation unit 15 receives the detection result 13 and determines an important area corresponding to the detection result. The important area holds information on a peripheral area including a detection area, and indicates an area important for the image recognition unit 2 to detect a defect.

The feature data extraction unit 16 weights the feature data extracted by the image recognition unit 2 using the important area calculated by the important area calculation unit 15 and extracts the feature data serving as a cause of the detection result, thereby outputting the feature data as the feature data corresponding to the detection result.

The feature data corresponding to the detection result identified by the feature data identifying unit 6 is stored in the inspection result feature data DB 17.

The learning result feature data DB 18 stores the feature data corresponding to each detection result determined by the feature data identifying unit 6 for the detection result of the image recognition unit 2 for the learning image used for learning of the image recognition unit 2. Details of a storage process in the learning result feature data DB 18 will be described later.

The dimension reduction unit 8 performs the dimension reduction on the result stored in the inspection result feature data DB 17 and the learning result feature data DB 18, and maps the results in a two-dimensional or three-dimensional low-dimensional space. According to the invention, a dimension reduction method for the dimension reduction unit 8 uses t-distributed stochastic neighbor embedding (t-SNE), whereas other dimension reduction algorithms such as principal component analysis or independent component analysis may be used.

The display unit 20 displays the result of the dimension reduction by the dimension reduction unit 8 and the result stored in the detection result DB 14.

A labeled training data creation unit 21 has a function of allowing a user to perform an operation of selecting data and labeling the selected data in response to the result displayed on the display unit 20, and the created labeled training data is stored in a labeled training data DB 22.

FIG. 3 is a flowchart showing a process performed by the labeled training data creation assistance device of FIG. 2.

First, in step S101, the inspection device 11 captures an image of the inspection image 12 on the sample 10.

Next, in step S102, the image recognition unit 2 predicts a type and a position of a defect appearing in the inspection image 12 with respect to the inspection image 12, and outputs the predicted type and position as the detection result 13. The detection result 13 is stored in the detection result DB 14.

Subsequently, in step S103, the important area calculation unit 15 determines, for each detection result of the detection result 13, an important area holding information on a peripheral area including the detection area.

Next, in step S104, the feature data extraction unit 16 weights the feature data extracted by the image recognition unit 2 using the important area determined by the important area calculation unit 15 to extract the feature data serving as a cause of the detection result, and stores the feature data in the inspection result feature data DB 17 for each class of the detection result and for each detection result.

Subsequently, in step S105, the dimension reduction unit 8 performs the dimension reduction on the feature data stored in the inspection result feature data DB 17 and the learning result feature data DB 18.

Next, in step S106, the display unit 20 displays the result of the dimension reduction unit 8.

Subsequently, in step S107, the labeled training data creation unit 21 stores the created labeled training data in the labeled training data DB 22.

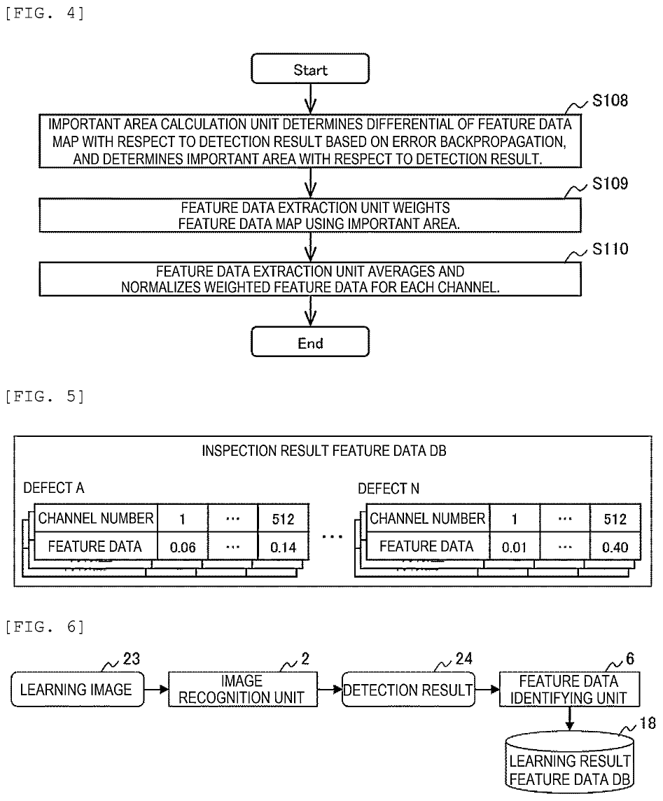

Details of the process contents of the important area calculation unit 15 and the feature data extraction unit 16 will be described with reference to FIGS. 4 and 5.

FIG. 4 is a flowchart showing a process of the feature data identifying unit 6 (the important area calculation unit 15 and the feature data extraction unit 16).

First, in step S108, the important area calculation unit 15 calculates a differential of a feature data map held by the image recognition unit 2 with respect to the detection result based on error backpropagation, and determines S_{k,c,box_pre} representing the important area with respect to the detection result. The feature data map holds the feature data extracted from the inspection image 12 by the image recognition unit 2. The process is shown in Formula (1).

$${S}_{k , c , box\_pre} = \frac{\vert \frac{\partial {y}_{c , box\_pre}}{\partial {A}_{k}} \vert}{max ( \vert \frac{\partial {y}_{c , box\_pre}}{\partial {A}_{k}} \vert )} \qquad ( 1 )$$

In Formula (1), y_{c,box_pre} is a score for a class c (defect type) predicted by the image recognition unit 2, and box_pre represents a predicted position. Aₖ represents a feature data map held by the image recognition unit 2, and k is a channel number.

S_{k,c,box_pre} obtained by Formula (1) represents a degree of importance of a space with respect to a prediction result (the class is c, and the position is box_pre) in each pixel of the feature data map of the channel number k, and the larger the numerical value when viewed for each pixel is, the more important the area is when outputting the prediction result y_{c,box_pre} (an area closer to 1 represents a more important area, and an area closer to 0 represents a less important area).

Information on the periphery of the detection area is also taken into account in the important area obtained by Formula (1). Therefore, when the image recognition model detects a defect by attaching importance to the area on the periphery of the detection area, the area is also output as a large value, as will be described later. In addition to the important area, in the detection area and a preset area on the periphery of the detection area, a mask that sets 1 inside the area and 0 outside the area, a preset template area, or the like can also be used. When a plurality of defects appear in the inspection image 12 and there are a plurality of detection results, the process of Formula (1) is performed for each detection result. Therefore, the important area corresponding to each detection result is obtained.

Next, in step S109, the feature data extraction unit 16 weights the feature data map held by the image recognition unit 2 with the important area determined by the important area calculation unit 15. The process is shown in Formula (2).

$${G}_{k , c , box\_pre} = {A}_{k} ∘ {S}_{k , c , box\_pre} \qquad ( 2 )$$

By the process of Formula (2), it is possible to extract the feature data which is the cause of the detection result from the feature data held by the feature data map. Similar to the calculation of the important area, the process of Formula (2) is performed for each detection result when there are a plurality of detection results.

Subsequently, in step S110, the feature data extraction unit 16 averages and normalizes the weighted feature data G_{k,c,box_pre} for each channel, and outputs the weighted feature data as the feature data corresponding to the detection result. Since G_{k,c,box_pre} is a two-dimensional tensor, it is possible to determine feature data that is a scalar value for each channel through the above process. For example, when the number of channels is 512, 512 types of feature data are obtained.

In the weighting shown in Formula (2), information indicating the degree of importance of each channel for the detection result may be included in the feature data map held by the image recognition unit 2. In this case, a process represented by the following Formula (3) is performed.

$${G}_{k , c , box\_pre} = ( {α}_{k , c , box\_pre} * {A}_{k} ) ∘ {S}_{k , c , box\_pre} \qquad ( 3 )$$

In Formula (3), α_{k,c,box_pre} represents the degree of importance of the feature data held by the feature data map of the channel number k with respect to the detection result, and is obtained by the following Formula (4).

$${α}_{k , c , box\_pre} = \frac{1}{z} {\sum }_{i}^{u} {\sum }_{j}^{v} \frac{\partial {y}_{c , box\_pre}}{\partial {A}_{i , j , k}} \qquad ( 4 )$$

In Formula (4), i and j represent vertical and horizontal pixel numbers of the feature data map, respectively, and u and v represent pixel numbers of the feature data map, respectively. In addition, z=u×V. Similar to the calculation of the important area, the process of Formula (4) is performed for each detection result when there are a plurality of detection results.

FIG. 5 shows an example of a storage form of the feature data corresponding to the detection result determined by the important area calculation unit 15 and the feature data extraction unit 16 in the inspection result feature data DB 17.

As shown in FIG. 5, the feature data corresponding to the detection result is stored for each class to be detected and for each detection result. In the example of FIG. 5, the class of the defect to be detected is present from a defect A to a defect N, and the feature data corresponding to each detection result is stored for each class.

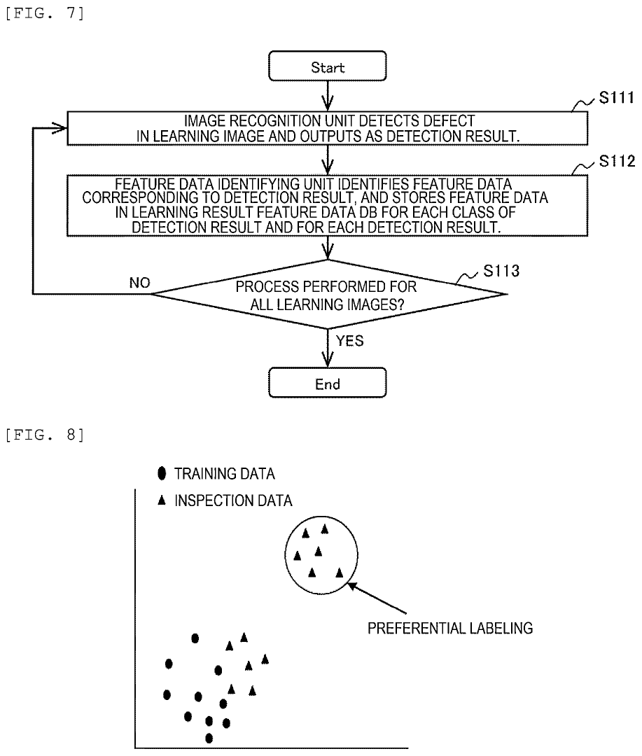

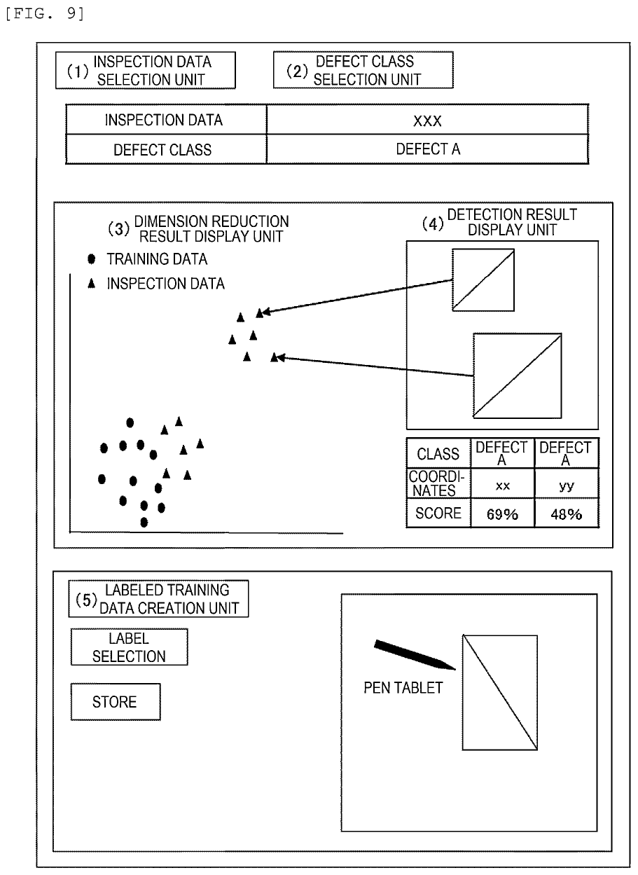

A storage process in the learning result feature data DB 18 will be described with reference to FIGS. 6 and 7.

FIG. 6 shows a system configuration necessary for the storage process in the learning result feature data DB 18.

A learning image 23 is training data used for learning of the image recognition unit 2.

The image recognition unit 2 detects a defect in the learning image 23 and outputs a detection result 24.

The feature data identifying unit 6 identifies the feature data corresponding to the detection result with respect to the detection result 24 and stores the feature data in the learning result feature data DB 18.

A part of the image used for learning may be used as the learning image 23.

FIG. 7 is a flowchart showing a process according to the system configuration of FIG. 6.

First, in step S111, the image recognition unit 2 detects the defect in the learning image 23 and outputs the defect as the detection result 24.

Next, in step S112, the feature data identifying unit 6 identifies the feature data corresponding to the detection result, and stores the feature data in the learning result feature data DB 18 for each class of the detection result and for each detection result. Process contents of the feature data identifying unit 6 at this time are the same as the process shown in the flowchart of FIG. 4. The feature data identified by the feature data identifying unit 6 is stored in the learning result feature data DB 18 in the same manner as the storage form in the inspection result feature data DB 17 shown in FIG. 5.

Subsequently, in step S113, it is determined whether the process is performed on all the learning images 23, and when it is determined that the process is performed on all the learning images 23 (YES), the process ends, and when it is determined that the process is not completed for all the learning images 23 (NO), the process returns to step S111, and the processes after step S111 are executed again.

FIG. 8 shows an example in which results stored in the inspection result feature data DB 17 and the learning result feature data DB 18 are mapped in a low-dimensional space by the dimension reduction unit 8. In FIG. 8, black circle points are data corresponding to the feature data stored in the learning result feature data DB 18, and black triangle points are data corresponding to the feature data stored in the inspection result feature data DB 17.

Since the inspection data present at a lower left part of FIG. 8 is present in almost the same area as the training data, the characteristics of the inspection data are similar to those of the training data. On the other hand, the inspection data present in an upper right part of FIG. 8 is present in an area away from the training data, and has characteristics different from the training data.

In general, an image recognition model causes performance degradation such as erroneous detection or overlooking for an image not included in the training data. Therefore, the user can efficiently create the labeled training data that enables improvement of the performance of the image recognition model by preferentially labeling the inspection image present in the upper right part of FIG. 8 to create the labeled training data.

The dimension reduction unit 8 performs the dimension reduction on data corresponding to each defect class. For example, when the dimension reduction is performed on the defect A, the dimension reduction is performed on the data corresponding to the defect A stored in the inspection result feature data DB 17 and the data corresponding to the defect A stored in the learning result feature data DB 18. In addition, the dimension reduction unit 8 may collectively perform the dimension reduction for all pieces of data instead of for each defect class.

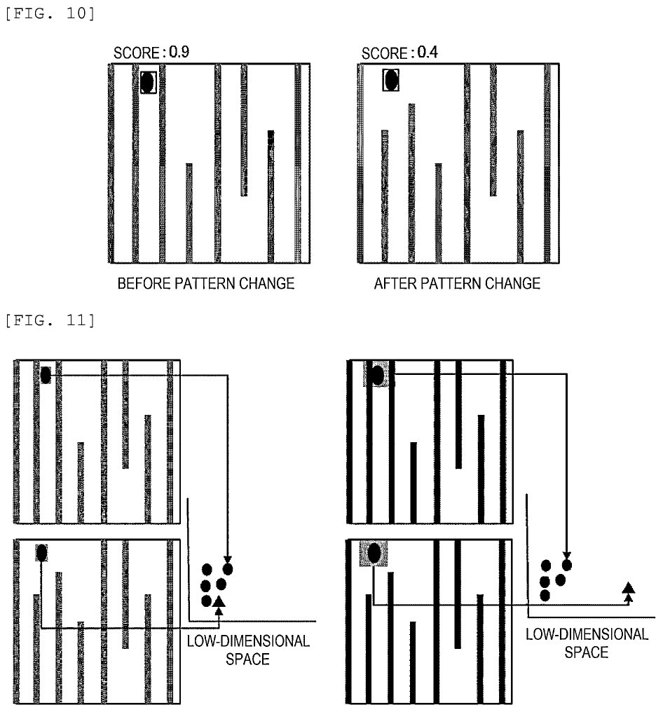

FIG. 9 is a diagram showing a display example of the display unit 20. As shown in FIG. 9, the display unit 20 displays a (1) inspection data selection unit, a (2) defect class selection unit, a (3) dimension reduction result display unit, a (4) detection result display unit, and a (5) labeled training data creation unit.

The (1) inspection data selection unit selects the inspection data, and the (2) defect class selection unit selects a defect class to be subjected to the dimension reduction.

The (3) dimension reduction result t display unit displays the dimension reduction result of the dimension reduction unit 8. At this time, data points corresponding to the feature data stored in the inspection result feature data DB 17 and data points corresponding to the feature data stored in the learning result feature data DB 18 are displayed in different colors or shapes.

The detection result of the image recognition unit 2 is displayed on the (4) detection result display unit. For example, a prediction class, a prediction area (coordinates), and a score representing a confidence level of prediction are displayed. At this time, the detection result is displayed in association with the data points displayed on the (3) dimension reduction result display unit. For example, when the data points displayed on the (3) dimension reduction result display unit are selected, detection results corresponding thereto are displayed, respectively.

In the invention, when there are a plurality of defects in the image and the image recognition unit 2 separately detects the defects, the number of data points after the dimension reduction is equal to the number of detection results. Therefore, for example, when the plurality of defects are present in the image and are detected separately, the data points corresponding to the defects are displayed separately.

The (5) labeled training data creation unit has a function of enabling a user to create the labeled training data using a pen tablet or the like for the results displayed on the (3) dimension reduction result display unit and the (4) detection result display unit. For example, an area in which the defect is present is selected, and a class of the defect is selected.

The (5) labeled training data creation unit may have a function of using the detection result of the image recognition unit 2 as a label candidate. For example, classes and areas predicted by the image recognition unit 2 are set as class candidates and area candidates.

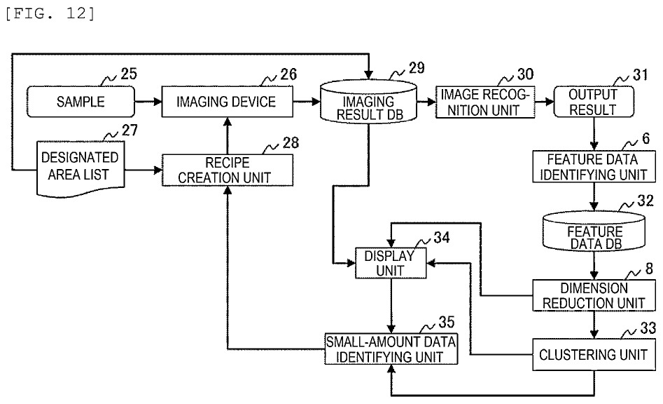

An operation of the important area calculation unit 15 will be described with reference to FIGS. 10 and 11. As described above, the important area calculation unit 15 determines the important area in consideration of a peripheral area including the detection area.

A left diagram of FIG. 10 shows an example in which a defect occurring in a circuit is detected with a score value of 0.9 representing a confidence level of prediction. As shown in the left diagram of FIG. 10, a circuit pattern is present around the defect. When such a circuit pattern is present in most of the training data used for learning the image recognition model, the circuit pattern that is present in the periphery of the defect is also learned, and thus importance is attached to the circuit pattern that is present in the periphery of the defect when the defect is detected. In this case, with respect to an image in which the circuit pattern is changed due to a change in a circuit manufacturing process or the like and there is no circuit pattern in the periphery of the defect, there is a chance that the defect is detected with a low score in the image recognition model in which the circuit pattern is memorized. This is shown in a right diagram of FIG. 10.

In general, a final output result of the image recognition model is determined by setting a score threshold value. For example, when the score threshold value is set to 0.6, only a result with a score of 0.6 or more is finally output. Accordingly, it is possible to exclude a detection result of a low score that is likely to be erroneous detection.

Therefore, there is a chance that the defect detected with the low score shown in the right diagram of FIG. 10 is excluded by the score threshold value. Therefore, in order to detect a defect as shown in the right diagram of FIG. 10 with a high score, it is necessary to preferentially collect images with no circuit pattern as shown in the right diagram of FIG. 10 and use the images as the labeled training data to learn the image recognition model.

As described above, in the invention, the feature data corresponding to the detection result is mapped to the low-dimensional space, thereby facilitating discovery of the image not included in the training data. In order to map the image after a pattern change as shown in the right diagram of FIG. 10 to an area different from the image before the pattern change as shown in the left diagram of FIG. 10 in the low-dimensional space, it is necessary to perform the dimension reduction on feature data including a defect to be detected and a peripheral area of the defect.

A left diagram of FIG. 11 shows an example of a result obtained by the dimension reduction of the feature data of only the defect to be detected. As shown in FIG. 1, since the feature data to be subjected to the dimension reduction is only the feature data of the defect to be detected, the feature data is mapped to the same area in the dimensional space before and after the pattern change.

A right diagram of FIG. 11 shows an example of a result obtained by the dimension reduction of the feature data including the peripheral area. By also considering the peripheral area, feature data of the defect and the peripheral circuit pattern are targeted for the dimension reduction before the pattern change, and therefore, the feature data are mapped to different areas on the low-dimensional space before and after the pattern change. Accordingly, it is possible to easily find the image after the pattern change.

The important area calculation unit 15 determines the defect to be detected and the peripheral area of the defect as shown in black frames in the right diagram of FIG. 11 as the important areas, and the feature data extraction unit 16 extracts the feature data in the important areas. Therefore, as shown in the right diagram of FIG. 11, the images before and after the pattern change can be mapped to different areas in the low-dimensional space.

### Embodiment 2

A labeled training data creation assistance device and a labeled training data creation assistance method using the same according to Embodiment 2 of the invention will be described.

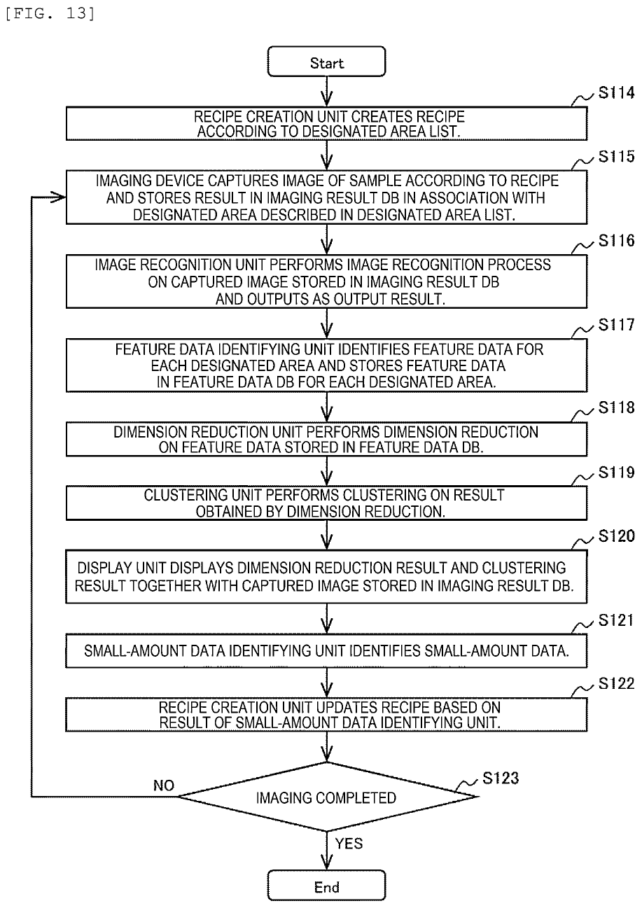

FIG. 12 is a block diagram showing a configuration of a labeled training data creation assistance device according to the embodiment.

An imaging device 26 captures an image of an inspection image of a sample 25 and stores the inspection image in the imaging result DB 29. The sample 25 is a semiconductor wafer, an electronic device, or the like, and the imaging device 26 is a scanning electron microscope (SEM) that generates an image by emitting an electron beam, a critical dimension-scanning electron microscope (CD-SEM) that is a type of a measurement device, or the like.

The imaging device 26 captures an image of the sample 25 according to a recipe created by a recipe creation unit 28. The recipe is a program for controlling the imaging device 26, and imaging conditions imaging position and the number of times of imaging are controlled by the recipe.

The recipe creation unit 28 creates a recipe according to a designated area list 27. The designated area list 27 is a list in which an imaging position is described, the imaging position being determined based on design data in which design information of the sample 25 is described and/or data in which imaging conditions of the imaging device 26 are described. The design data is expressed in, for example, a graphic data system (GDS) format. The designated area list 27 may be imaging position information set in advance by the user.

In the imaging result DB 29, a captured image captured by the imaging device 26 is stored in association with the area information described in the designated area list 27.

An image recognition unit 30 performs an image recognition process on the captured image stored in the imaging result DB 29 and outputs an output result 31. The image recognition unit 30 is, for example, an image recognition model that predicts a class appearing in a designated area, an image recognition model that predicts a class for each pixel of an image, or an image recognition model that compresses an input image once and then restores the image to an original dimension, all of which are constructed using CNN.

The feature data identifying unit 6 identifies the feature data corresponding to each designated area described in the designated area list 27 according to the output result 31, and stores the feature data in a feature data DB 32. At this time, the feature data corresponding to each designated area is separately stored in the feature data DB 32. Therefore, when there are a plurality of designated areas for one inspection image, the feature data are stored separately.

The dimension reduction unit 8 performs the dimension reduction on the result stored in the feature data DB 32.

A clustering unit 33 performs clustering, which is dividing results of the dimension reduction unit 8 into a plurality of groups, based on a degree of similarity between data after the dimension reduction. The clustering unit 33 uses, for example, a k-means algorithm.

The display unit 34 displays the results of the dimension reduction unit 8 and the clustering unit 33 in association with the information stored in the imaging result DB 29. The display unit 34 has a function in which the user can manually cluster the result of the dimension reduction unit 8 and a function in which the user can manually select data.

A small-amount data identifying unit 35 identifies small-amount data based on the result of the clustering unit 33 and/or the display unit 34. This is implemented by counting the number of pieces of data included in each area obtained by a clustering process. The small-amount data corresponds to an image of a pattern having a smaller number of images than other patterns when the inspection image captured by the imaging device 26 is divided into a plurality of patterns.

The recipe creation unit 28 has a function of updating the imaging position and the number of times of imaging based on the result identified by the small-amount data identifying unit 35 and reflecting the imaging position and the number of times of imaging in the recipe. Specifically, the number of times of imaging is preferentially increased for an image identified as the small-amount data. Accordingly, it is possible to equalize the number of images for each pattern with respect to the entire captured image.

FIG. 13 is a flowchart showing a process performed by the labeled training data creation assistance device of FIG. 12.

First, in step S114, the recipe creation unit 28 creates a recipe according to the designated area list 27.

Subsequently, in step S115, the imaging device 26 captures an image of the sample 25 according to the recipe and stores the image in the imaging result DB 29 in association with the designated area described in the designated area list 27.

Next, in step S116, the image recognition unit 30 performs the image recognition process on the captured image stored in the imaging result DB 29, and outputs the result as the output result 31.

Subsequently, in step S117, the feature data identifying unit 6 identifies the feature data for each designated area and stores the feature data in the feature data DB 32 for each designated area.

Next, in step S118, the dimension reduction unit 8 performs the dimension reduction on the feature data stored in the feature data DB 32.

Subsequently, in step S119, the clustering unit 33 performs the clustering on the result obtained by the dimension reduction.

Next, in step S120, the display unit 34 displays a dimension reduction result and a clustering result together with the captured image stored in the imaging result DB 29.

Subsequently, in step S121, the small-amount data identifying unit 35 identifies the small-amount data.

Next, in step S122, the recipe creation unit 28 updates the recipe based on the result of the small-amount data identifying unit 35.

Subsequently, in step S123, it is determined whether the imaging is completed, and when it is determined that the imaging is completed (YES), the process ends, and when it is determined that the imaging is not completed (NO), the process returns to step S115, and the processes after step S115 are executed again.

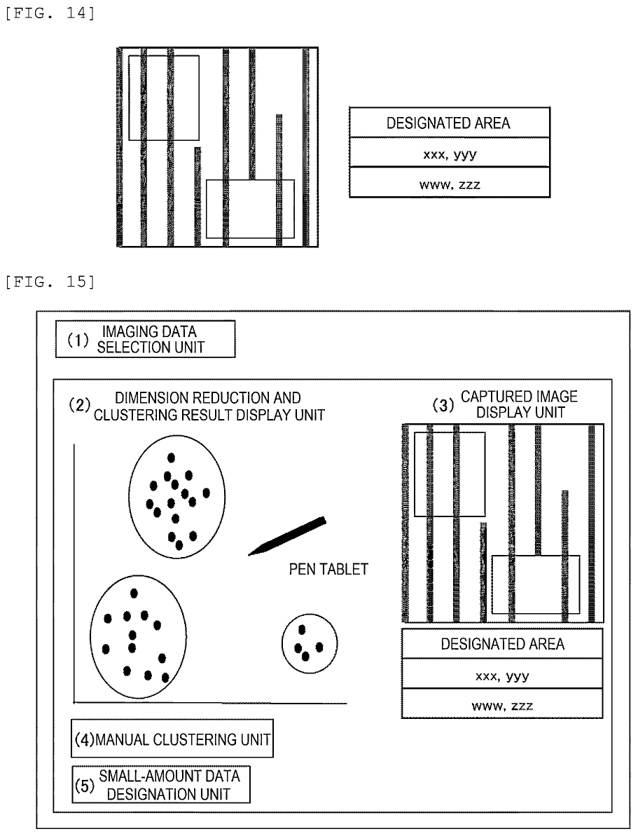

FIG. 14 shows an example of storage in the imaging result DB 29. As shown in FIG. 14, the captured image and the designated area described in the designated area list 27 are stored in association with each other.

FIG. 15 is a display example of the display unit 34. As shown in FIG. 15, the display unit 34 displays a (1) imaging data selection unit, a (2) dimension reduction and clustering result display unit, a (3) captured image display unit, a (4) manual clustering unit, and a (5) small-amount data designation unit.

The (1) imaging data selection unit selects the imaging data.

The results of the dimension reduction unit 8 and the clustering unit 33 are displayed in the (2) dimension reduction and clustering result display unit.

The captured image stored in the imaging result DB 29 is displayed on the (3) captured image display unit. At this time, the captured image is displayed in association with the (2) dimension reduction and clustering result display unit. For example, when a data point displayed in the (2) dimension reduction and clustering result display unit is selected, an image and a designated area corresponding to the data are displayed.

The (4) manual clustering unit has a function of allowing the user to manually cluster the data displayed in the (2) dimension reduction and clustering result display unit. For example, the clustering is performed by selecting an area using a pen tablet or the like.

The (5) small-amount data designation unit has a function of allowing the user to manually designate the small-amount data. For example, the designation is performed by selecting the data displayed in the (2) dimension reduction and clustering result display unit using the pen tablet or the like.

The invention is not limited to the embodiments described above, and includes various modifications. For example, the embodiments described above have been described in detail to facilitate understanding of the invention, and the invention is not necessarily limited to those including all the configurations described above. A part of a configuration according to one embodiment can be replaced with a configuration according to another embodiment, and a configuration according to one embodiment can also be added to a configuration according to another embodiment. A part of a configuration according to each embodiment may be added, deleted, or replaced with another configuration.

### REFERENCE SIGNS LIST

1, 12: inspection image
2, 30: image recognition unit
3, 4, 5, 13, 24: detection result
6: feature data identifying unit
7: feature data DB
8: dimension reduction unit
9, 20: display unit
10, 25: sample
11: inspection device
14: detection result DB
15: important area calculation unit
16: feature data extraction unit
17: inspection result feature data DB
18: learning result feature data DB
21: labeled training data creation unit
22: labeled training data DB
23: learning image
26: imaging device
27: designated area list
28: recipe creation unit
29: imaging result DB
31: output result
32: feature data DB
33: clustering unit
34: display unit
35: small-amount data identifying unit

1. A labeled training data creation assistance device comprising:
an image recognition unit configured to extract, based on a learning result, feature data from an input image, perform an image process with the feature data, and output a recognition result;
a feature data identifying unit configured to receive one or more prediction results from the image recognition unit or designated areas as an input, and identify the feature data corresponding to each of the prediction results or each of the detection areas;
an inspection result feature data database in which the feature data for each of the prediction results or each of the designated areas is stored; and
a dimension reduction unit configured to perform dimension reduction on the feature data stored in the inspection result feature data database and project the feature data onto a low-dimensional space, wherein
the feature data identifying unit includes, for each of the prediction results or each of the designated areas, an important area calculation unit configured to determine an important area that holds information on a peripheral area including a detection area of the prediction result or the designated area, and
a feature data extraction unit configured to extract the feature data corresponding to each of the prediction results or each of the designated areas by weighting the feature data extracted by the image recognition unit using the important area.

2. The labeled training data creation assistance device according to claim 1, wherein
the important area calculation unit determines, for each of the prediction results or each of the designated areas, the important area based on error backpropagation and the feature data.

3. The labeled training data creation assistance device according to claim 1, further comprising:
a learning result feature data database in which, for one or more of the prediction results of the image recognition unit or the designated areas with respect to an image used for learning by the image recognition unit, the feature data determined for each of the prediction results or each of the designated areas obtained by the feature data identifying unit is stored for each of the prediction results or each of the designated areas, wherein
the dimension reduction unit performs the dimension reduction on the feature data stored in the inspection result feature data database and the learning result feature data database, and projects the feature data onto a low-dimensional space.

4. The labeled training data creation assistance device according to claim 3, further comprising:
a display unit configured to display a processing result of the dimension reduction unit, wherein
the display unit displays a data point after the dimension reduction corresponding to the feature data stored in the inspection result feature data database and a data point after the dimension reduction corresponding to the feature data stored in the learning result feature data database in different colors or shapes.

5. The labeled training data creation assistance device according to claim 4, wherein
the display unit has a function of displaying the processing result of the dimension reduction unit and the prediction result of the image recognition unit or the designated area in association with each other, and
a labeled training data creation unit configured to create new labeled training data based on a display content of the display unit.

6. The labeled training data creation assistance device according to claim 1, further comprising:
a clustering unit configured to divide each data point projected onto the low-dimensional space by the dimension reduction unit into a plurality of area sets;
a display unit configured to display a processing result of the dimension reduction unit and a processing result of the clustering unit; and
a small-amount data identifying unit configured to identify small-amount data by calculating the number of pieces of data for each area based on the processing result of the clustering unit.

7. The labeled training data creation assistance device according to claim 6, further comprising:
a recipe creation unit configured to create a recipe in which imaging conditions including an imaging position or the number of times of imaging are described; and
an imaging device configured to capture an image of a sample based on the recipe, wherein
the input image is an image captured by the imaging device, and
the recipe creation unit updates a content of the recipe based on the small-amount data identified by the small-amount data identifying unit.

8. The labeled training data creation assistance device according to claim 6, wherein
the display unit has a function of allowing a user to manually perform area division for each data point or designation of the small-amount data with respect to the processing results of the dimension reduction unit and the clustering unit.

9. The labeled training data creation assistance device according to claim 5, wherein
the labeled training data creation unit uses the prediction result of the image recognition unit or the designated area as a candidate for a label to be assigned to the image.

10. The labeled training data creation assistance device according to claim 1, wherein
the image recognition unit performs the image process by machine learning using a convolution neural network (CNN).

11. The labeled training data creation assistance device according to claim 1, wherein
the dimension reduction unit performs the dimension reduction using t-distributed stochastic neighbor embedding (t-SNE).

12. The labeled training data creation assistance device according to claim 1, wherein
the important area calculation unit determines, in addition to the important area, for each of the prediction results or each of the designated areas, a degree of importance of the feature data based on error backpropagation and the feature data, and
the feature data extraction unit extracts the feature data corresponding to each of the prediction results or each of the designated areas by weighting the feature data using the important area and the degree of importance.

13. The labeled training data creation assistance device according to claim 1, wherein
the important area calculation unit determines a preset peripheral range as the important area for the detection area of the prediction result or the designated area.

14. The labeled training data creation assistance device according to claim 1, wherein
the prediction result is a type and a position of an object appearing in the input image predicted by the image recognition unit.

15. The labeled training data creation assistance device according to claim 1, wherein
the designated area is an area calculated based on pattern data used to manufacture a sample to be inspected and/or data describing imaging conditions for the sample.

16. The labeled training data creation assistance device according to claim 1, wherein
the designated area is an area preset by a user.

17. A labeled training data creation assistance method for assistance of creation of labeled training data in machine learning, the method comprising:
(a) a step of individually detecting types and positions of a plurality of defects appearing in an inspection image;
(b) a step of identifying feature data for each defect based on a result detected in step (a) and storing the feature data in a database; and
(c) a step of performing dimension reduction on the feature data stored in the database, projecting the feature data onto a low-dimensional space, and displaying a result of projection on a display unit.
